(19) United States
(12) Patent Application Publication
(10) Pub. No.: US 2005/0016599 A1
(43) Pub. Date: Jan. 27, 2005

(54) Pressure control valve

(76) Inventor: Edward J. Talaski, Caro, MI (US)

Correspondence Address: Reising, Ethington, Barnes, Kisselle, PC, P.O. Box 4390, Troy, MI, 48099-4390, US

(21) Appl. No.: 10/624,174

(22) Filed: Jul. 22, 2003

(51) Int. Cl. F16K 15/04

(52) U.S. Cl. 137/539

(57) ABSTRACT

A pressure control valve has a non-uniformly tapered valve bore that has an increasing diameter as it extends downstream. An interface angle, defined in part between a valve ball and the valve bore in the area of the smallest gap between them, increases as the valve ball is increasingly displaced away from a valve seat of the valve bore.

### FIELD OF THE INVENTION

This invention relates to a valve, and more particularly to a fluid pressure control valve.

### BACKGROUND OF THE INVENTION

Hydraulic circuits incorporate valves such as pressure relief valves for various reasons, including to protect components, and to ensure the operational safety of the system. There are various valves in the prior art that are used to control the pressure of fluids, which include liquids and gases. One valve uses a sphere or valve ball yieldably biased by a spring or other mechanism against a valve seat to seal the valve and control the, “cracking” or initial opening pressure, and relief pressure. Once the cracking pressure is reached, the valve ball is forced off of the valve seat, and fluid flows through the valve seat. The valve ball moves back onto the valve seat by the biasing mechanism when the pressure is reduced and the relief pressure is reached.

Valves having a valve bore of a cylindrical or frustoconical shape can have undesirable changes in operating pressure at various flow rates, including especially, high flow rates. These valves typically require unduly increased fluid pressure to cause increased valve opening, and this can cause, for example, variation in operating characteristics relative to fluid flow rate.

### SUMMARY OF THE INVENTION

A pressure control valve has a non-uniformly tapered valve bore that has an increasing diameter as it extends downstream. An interface angle, defined between a valve ball and the valve bore in the area of the smallest gap between them, increases as the valve ball is increasingly displaced away from a valve seat of the valve bore.

As the interface angle increases, the effective surface area of the valve ball acted upon by upstream fluid pressure increases, providing increased force acting on the ball from the upstream fluid. In this regard, the change in the interface angle, and hence the change in the effective surface area of the valve ball, can be controlled with regard, for example, to the spring constant of a spring that yieldably biases the ball against the valve seat. In one form, the valve can be used as a pressure relief valve and the interface angle and hence, the effective surface area of the valve ball, can be made to offset the increased spring force acting on the valve ball as it is increasingly displaced away from the valve seat. Thus, a relatively flat or constant pressure curve can be obtained for the relief valve over a wide range of fluid flow rates. Of course, the valve can be used in applications other than as a pressure relief valve.

In one presently preferred embodiment, the valve bore has a frustoconical portion defining the valve seat and a concave portion downstream of the frustoconical portion, with the concave portion being non-linearly or non-uniformly and preferably arcuately tapered. In another presently preferred embodiment, the valve bore has a plurality of straight, linearly tapered segments disposed at varying angles such that the valve bore does not have a straight or constant linear taper along its entire axial length.

### BRIEF DESCRIPTION OF THE DRAWINGS

These and other objects, features and advantages of the present invention will be apparent from the following detailed description of the preferred embodiments, appended claims and accompanying drawings in which:

FIG. 1 is an end view of a pressure control valve according to one presently preferred embodiment of the invention;

FIG. 2 is a cross-sectional view taken generally along line 2-2 in FIG. 1;

FIG. 3 is a cross-sectional view taken generally along line 3-3 in FIG. 1;

FIG. 4 is a fragmentary sectional view of another embodiment of a pressure control valve illustrating a valve ball in its closed position on a valve seat;

FIG. 5 is a fragmentary sectional view like FIG. 4 illustrating the valve ball displaced a first distance from the valve seat;

FIG. 6 is a fragmentary sectional view like FIG. 4 illustrating the valve ball displaced a second distance from the valve seat;

FIG. 7 is a fragmentary sectional view like FIG. 4 illustrating the valve ball displaced a third distance from the valve seat;

FIG. 8 is a fragmentary sectional view of a pressure control valve constructed according to another presently preferred embodiment of the invention; and

FIG. 9 is a graph of a pressure curve for one exemplary pressure control valve.

### DETAILED DESCRIPTION OF THE PREFERRED EMBODIMENTS

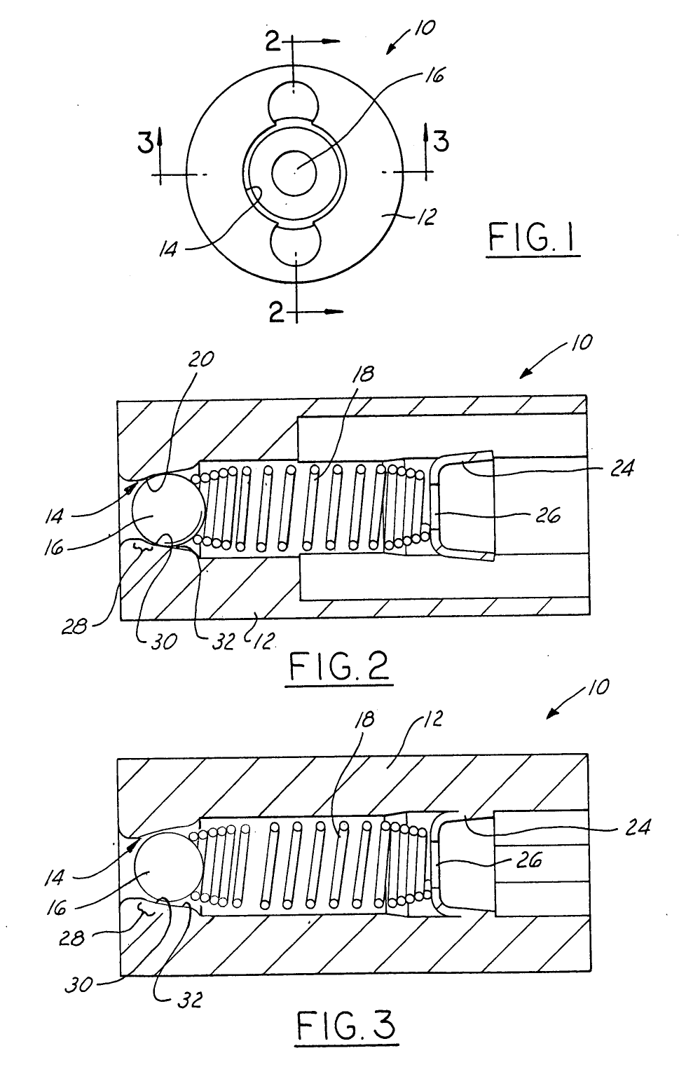

Referring in more detail to the drawings, FIGS. 1-3 illustrate a pressure control valve 10 having a valve body 12 with a valve bore 14 formed therein, and a valve head 16, shown in this embodiment as a spherical ball, disposed within the valve bore 14 to control the flow of fluid through the bore. In one presently preferred embodiment, the pressure control valve 10 acts as a pressure relief valve. The valve ball 16 is yieldably biased, such as by a spring 18, against a valve seat 20 portion of the valve bore 14 which has a diameter smaller than the diameter of the valve ball. When the valve ball 16 is seated against the valve seat 20, fluid does not flow through the valve bore 14. When the pressure of fluid upstream of the valve seat 20 exceeds a predetermined maximum fluid pressure, the valve ball 16 is displaced by the force of the fluid against the force of the spring 18, providing a flow area or a gap 22 (e.g. as shown in FIGS. 5-7) between the valve ball 16 and the valve bore 14 through which fluid may flow. When the pressure of the fluid drops below the predetermined maximum fluid pressure, the valve ball 16 again will become seated on the valve seat 20.

The operating pressure of the valve 10 can be controlled by the initial spring force and the spring rate of the spring 18 that yieldably biases the valve ball 16 against the valve seat 20. The initial spring force can be changed by varying the initial compression of the spring 18, such as by adjusting the position of a spring seat 24 preferably pressed into the valve bore 14 behind the spring 18. The spring seat 24 preferably has an interference fit with the valve bore 14 and includes an opening 26 through which fluid may flow.

In the presently preferred embodiment, the valve seat 20 is defined in a generally linearly tapered or frustoconical portion 28 of the valve bore 14. This frustoconical portion 28 extends axially and radially outwardly as it extends downstream to a transition point 30 at the downstream end of the frustoconical portion. Downstream of the transition 30, a concave portion 32 is formed in the valve bore 14.

The concave portion 32 has a diameter that increases from its upstream end to its downstream end. The diameter of the concave portion 32 does not increase linearly as in the frustoconical section 28. Rather, the valve bore 14 in the area of the concave portion 32 is somewhat curved or arcuate. Accordingly, as the concave portion 32 extends downstream its diameter increases as a function of the curvature of the valve bore 14 in this area. The minimum gap or flow area 22 between the valve body 12 and the valve ball 16 varies as a function of the axial displacement of the valve ball 16 away from the valve seat 20. The minimum gap or flow area 22 is defined by the portion of the valve bore 14 that is closest to the valve ball 16, and this changes as the valve ball is displaced relative to the valve seat.

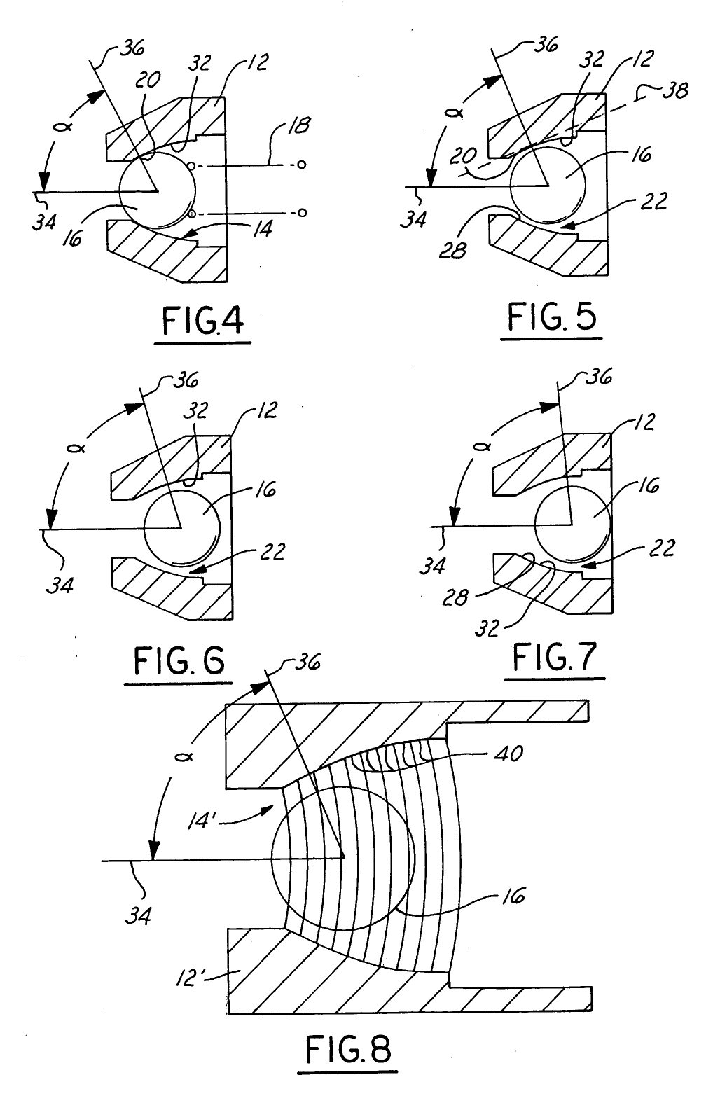

As shown in FIGS. 4-7, which illustrate an alternate embodiment valve having a valve bore of slightly different shape than in FIGS. 1-3, an interface angle α is defined between an axis 34 of the valve bore 14, and an interface line 36 that defines the shortest distance between the valve head and the valve bore 14. In other words, the interface line 36 connects the point on the valve head and the point on the valve bore 14 that define the minimum gap between the valve head and valve bore. With a spherical valve ball 16 as the valve head, the interface line 36 intersects the center of the valve ball 16 and the surface of the valve bore 14 closest to the valve ball 16. As shown in FIG. 5, at least with a curved or arcuate concave portion 32 and a spherical valve ball 16, the interface line 36 is perpendicular to a line 38 tangent to the valve bore at the location of the valve bore that is closest to the valve ball for a particular axial position of the valve ball. As illustrated in FIGS. 4-7, the interface angle α increases as the valve ball 16 is displaced further away from the valve seat 20. This is due to the non-uniform increase in the diameter of the concave portion 32 of the valve bore 14 as it extends downstream.

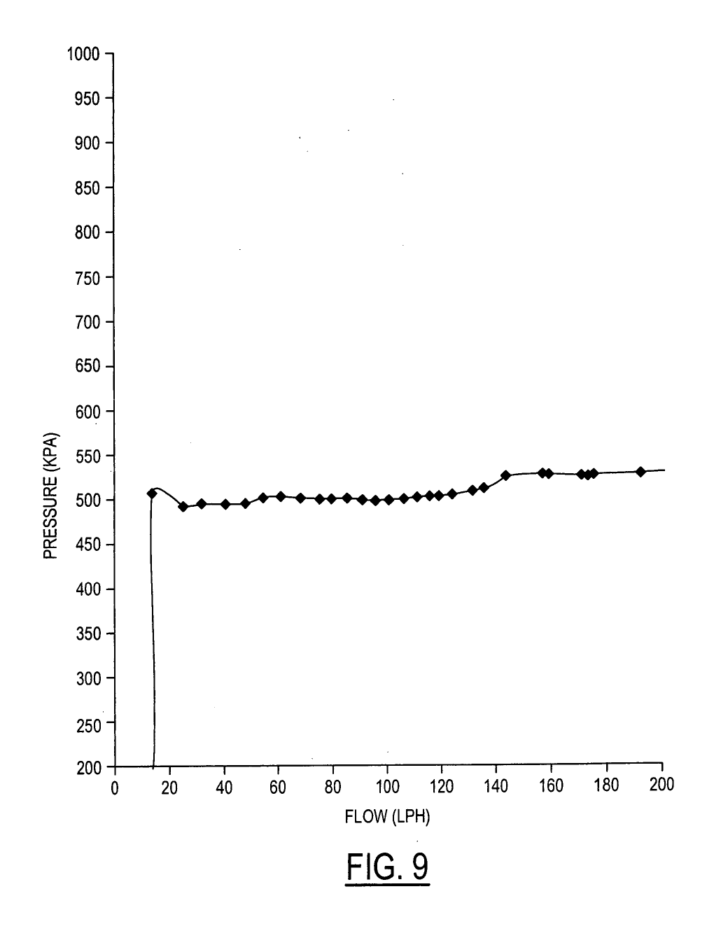

During operation, the effective surface area of the valve ball 16 that is acted upon by the fluid upstream of the valve seat 20 is proportional to the interface angle α. As the interface angle α increases, the effective surface area of the ball 16 that is subjected to the upstream fluid pressure also increases. For a given fluid pressure, the increased effective surface of the valve ball 16 tends to increase the force acting on the valve ball by the upstream fluid pressure. There is also a factor called the “Bernoulli Effect” that tends to decrease the pressure force on the valve ball 16 due to the velocity of the fluid in the flow gap 22. The “Bernoulli Effect” can be reduced by decreasing the minimum flow gap 22 at a fixed axial position of the ball 16. This force produced by the upstream fluid pressure is offset by the force of the spring 18, which likewise increases as the valve ball 16 is displaced further away from the valve seat 20, causing increased compression of the spring 18. Accordingly, the pressure control valve 10 can be designed to offset the increased spring force as the spring 18 is increasingly compressed, by increasing the effective surface area of the ball 16 and or decreasing the minimum flow gap 22 as the ball 16 is displaced further away from the valve seat 20. In this manner, the valve 10 can be constructed to provide a desired pressure curve or response over a wide range of fluid flow rates. For example, the valve 10 can be designed to have a relatively flat pressure curve over a wide range of flow rates as shown in FIG. 9 wherein the flow rate varies from about 10 or 20 liters per hour to about 200 liters per hour. The fluid flow rates may be even higher, on the order of 250 liters per hour, or more, as needed. Of course the pressure response or curve can be controlled as desired for a desired application or use of a pressure control valve.

One way to design a valve 10 is to determine the desired minimal clearance between the valve ball 16 and the valve bore 14 in various axial displacement positions of the valve ball 16, to oppose as desired the spring force acting on the ball, which is a known function of the spring constant of the spring 18. In other words, for a given displacement of the valve ball 16, the spring force acting on the ball can be readily calculated, and this force can be offset as desired with a desired net force in the opposite direction which is a function of the force of the fluid acting on the valve ball 16. Since the force of the fluid acting on the valve ball 16 is a function of the upstream pressure, axial position, interface angle and minimum flow gap 22, it can be calculated using Computational Fluid Dynamics (CFD) analysis or other numerical analysis. The analysis shows that the force increases as the minimum flow gap 22 is decreased and the force decreases as the minimum flow gap 22 is increased. In this manner, the shape or contour of the concave portion 32 can be iteratively determined with relative precision for a desired pressure characteristic or pressure response of the pressure control valve 10.

When the valve is closed, in other words the valve ball 16 is on the valve seat 20, the interface angle α is preferably between about 5° to about 85°, and more preferably between 35° and 75°. At very low interface angles, there is a relatively small surface area of the valve ball 16 subjected to the upstream fluid pressure, which may adversely affect its responsiveness. On the other hand, at a very large starting interface angle, issues such as corking or the tendency of the valve ball 16 to become stuck on the valve seat 20 can occur. Also, starting at a very large interface angle α reduces the increase in the interface angle α that is possible as the valve ball 16 is displaced because the maximum interface angle with a spherical valve ball is 90°, which is coincident with the diameter of the ball perpendicular to the direction of the fluid flow. In other words, the 90° interface angle α defines the maximum effective surface area of the valve ball 16.

In the embodiment shown in FIGS. 4-7, the interface angle α increases from a nominal angle of about 65° when the valve ball 16 is closed on the valve seat 20, to about 68° in FIG. 5 where the valve ball 16 is shown displaced from its closed position and away from the valve seat 20. In FIG. 6, the valve ball 16 is displaced further away from the valve seat 20 than in FIG. 5 and the interface angle α is shown nominally at about 74°. Finally, in FIG. 7 the valve ball 16 is displaced still further away from the valve seat 20 and the interface angle α is a nominal angle of about 85°. These representative angles are illustrative of only a single presently preferred embodiment, and are not intended to limit the invention.

The frustoconical portion 28 may provide a more consistent interface angle α when the valve ball 16 is seated against the valve seat 20, and may minimize the effect of changes in the valve body 12, such as may occur with use of a plastic valve body immersed in liquid fuel which tends to cause swelling of plastic. Since the interface angle α remains constant in the frustoconical portion 28 with a linearly tapered surface, a change in the valve bore diameter in this area will cause the valve ball 16 to engage the frustoconical portion 28 in a different axial location, but it will not change the interface angle α. Hence, such a change will not change the effective surface area of the valve ball 16 that is acted on by the upstream fluid pressure. In this manner, the “cracking” or initial opening pressure of the valve 10 will not be affected by such changes in the housing.

If desired, the valve bore 14 can be formed without any frustoconical portion 28. The entire valve bore 14 can be made with a non-linear or non-uniform taper as described with reference to the concave portion 32 of the embodiment just described. The non-uniform taper provides a varying rate of change of the diameter of the valve bore 14 for given increments of axial distance. Alternatively, as shown in FIG. 8, a valve body 12′ may have a valve bore 14′ with a plurality of linearly tapered segments 40 disposed at different angles from one another. While each individual segment 40 has a straight linear taper, the valve bore 14 as a whole does not have a straight linear taper along its entire axial length. As also shown in FIG. 8, the interface line 36 may be generally perpendicular to the linear segment closest to the valve ball 16, and the interface angle α is defined between the axis 34 of the valve bore 14′ and the interface line 36.

Of course, still other modifications, variations or arrangements will be apparent to those of ordinary skill in the art. The preceding description of the presently preferred embodiments of the invention has been provided in terms of illustration, and not limitation. Several alternate constructions and arrangements have been disclosed, and as mentioned above, others will be apparent to persons of ordinary skill in the art, all of which fall within the spirit and scope of the invention as defined by the appended claims. For example, without limitation, the valve head has been shown as a spherical valve ball, but the valve head could take on other shapes or arrangements, as desired for an application or use of the valve.

1. A pressure control valve, comprising:
a valve body having a valve bore with a valve seat and a longitudinal axis, the valve bore having at least a portion with a diameter that increases non-uniformly from its upstream end closest to the valve seat to its downstream end; and
a valve head received at least in part in the valve bore, yieldably biased to a closed position against the valve seat, and being moveable to an open position spaced from the valve seat to allow fluid to flow through the valve bore;
an interface angle is defined at least when the valve head is displaced from the valve seat, the interface angle being defined between said longitudinal axis and an interface line intersecting a point on the valve head closest to the valve bore and a point of the valve bore closest to the valve head, and said interface angle increases as the valve head is increasingly displaced from the valve seat.

2. The pressure control valve of claim I which also comprises a spring yieldably biasing the valve head against the valve seat, the spring being disposed downstream of the valve head such that increasing displacement of the valve head away from the valve seat causes increasing displacement of the spring.

3. The pressure control valve of claim 1 wherein the valve bore has a concave portion with a diameter that increases non-linearly as the concave portion extends downstream.

4. The pressure control valve of claim 1 wherein the concave portion is generally arcuate.

5. The pressure control valve of claim 1 wherein the valve bore is defined at least in part by a plurality of linearly tapered segments arranged so that the valve bore as a whole is not linearly tapered along its entire axial length.

6. The pressure control valve of claim 1 wherein the valve head is a spherical valve ball having a diameter that is greater than the diameter of the valve bore in the area of the valve seat.

7. The pressure control valve of claim 6 wherein the interface line intersects the center of the valve ball and the location of the valve bore closest to the valve ball.

8. The pressure control valve of claim 5 wherein the interface line is defined within the portion of the valve bore defined by said plurality of linearly tapered segments and the interface line is perpendicular to the valve bore in at least some positions of the valve head when the valve head is spaced from the valve seat.

9. The pressure control valve of claim 2 wherein the spring is a coil spring having a spring rate and increased displacement of the valve head away from the valve seat causes an increase in the force of the spring acting on the valve head, the valve bore being constructed so that the interface angle increases as a function of the spring rate of the spring.

10. The pressure control valve of claim 9 wherein the interface angle increases as a function of the spring rate of the spring to offset the increased spring force that acts on the valve head as the valve head is increasingly displaced from the valve seat.

11. The pressure control valve of claim 10 wherein the interface angle increases as the valve head is increasingly displaced from the valve seat so that the valve has a substantially constant pressure response for fluid flow rates through the valve of between about 10 liters per hour and 250 liters per hour.

12. A pressure control valve, comprising:
a valve body having a valve bore with a valve seat and a longitudinal axis, the valve bore having at least a portion with a diameter that increases non-uniformly from its upstream end closest to the valve seat to its downstream end; and
a valve ball yieldably biased to a closed position against the valve seat, and being moveable to an open position spaced from the valve seat to allow fluid to flow through the valve bore;
an interface angle is defined between said longitudinal axis and a line intersecting a center of the valve ball and the location of the valve bore closest to the valve ball, and said interface angle increases as the valve ball is increasingly displaced from the valve seat.

13. The pressure control valve of claim 12 which also comprises a spring yieldably biasing the valve ball against the valve seat, the spring being disposed downstream of the valve ball such that increasing displacement of the valve ball away from the valve seat causes increasing displacement of the spring.

14. The pressure control valve of claim 12 wherein the valve bore has a concave portion with a diameter that increases non-linearly as the concave portion extends downstream.

15. The pressure control valve of claim 12 wherein the concave portion is generally arcuate.

16. The pressure control valve of claim 12 wherein the valve bore is defined at least in part by a plurality of linearly tapered segments arranged so that the valve bore as a whole is not linearly tapered along its entire axial length.

17. The pressure control valve of claim 13 wherein the spring is a coil spring having a spring rate wherein increased displacement of the valve head away from the valve seat causes an increase in the force of the spring acting on the valve head, the valve bore being constructed so that the interface angle increases as a function of the spring rate of the spring.

18. The pressure control valve of claim 17 wherein the interface angle increases as a function of the spring rate of the spring to offset the increased spring force that acts on the valve head as the valve head is increasingly displaced from the valve seat.

19. The pressure control valve of claim 18 wherein the interface angle increases as the valve head is increasingly displaced from the valve seat so that the valve has a substantially constant pressure response for fluid flow rates through the valve of between about 10 liters per hour and 250 liters per hour.

20. A pressure control valve, comprising:
a valve body having a valve bore through which a fluid may flow, the valve bore having a valve seat, a longitudinal axis and at least a portion with a diameter that increases non-uniformly from its upstream end closest to the valve seat to its downstream end; and
a valve ball yieldably biased to a closed position against the valve seat, and being moveable to an open position spaced from the valve seat to allow fluid to flow through the valve bore around the valve ball, for a given position of the valve ball relative to the valve seat an effective surface area of the valve ball is acted upon by the fluid tending to displace the ball in a direction away from the valve seat, and the effective surface area of the valve ball that is acted upon by the fluid increases as the valve ball is increasingly displaced away from the valve seat.

21. The pressure control valve of claim 20 wherein the effective surface area of the valve ball that is acted on by the fluid is a function of an interface angle defined between the longitudinal axis of the valve bore and an interface line that defines the shortest distance between the valve ball and the valve bore, and said interface angle increases as the valve ball is increasingly displaced from the valve seat.

22. The pressure control valve of claim 20 wherein the non-uniform portion of the valve bore is generally arcuate.

23. The pressure control valve of claim 20 wherein the non-uniform portion of the valve bore is defined at least in part by a plurality of linearly tapered segments arranged so that the valve bore as a whole does not have a straight linear taper along its entire axial length.

24. A method of making a pressure control valve, comprising the steps of:
forming a valve bore in a valve body so that the valve bore has a longitudinal axis, a valve seat and a non-uniform portion with a diameter that increases as the non-uniform portion extends away from the valve seat;
inserting a valve ball into the valve bore, the valve ball having a diameter greater than the diameter of the valve bore in the area of the valve seat but less than the diameter of the valve bore in the area of the non-uniform portion of the valve bore;
inserting a spring at least partially in the valve bore so that one end of the spring can engage and yieldably bias the valve ball toward the valve seat;
wherein, at least when the valve ball is displaced from the valve seat, an interface angle is defined between said longitudinal axis and an interface line intersecting a point on the valve head closest to the valve bore and a point of the valve bore closest to the valve head, and said step of forming the valve bore includes forming the non-uniform portion of the valve bore so that the interface angle increases as the valve head is increasingly displaced from the valve seat.

25. The method of claim 24 wherein the step of forming the valve bore including forming the non-uniform portion of the valve bore so that the interface angle increases as the valve head is increasingly displaced from the valve seat, is performed by calculating the spring force at various positions of the valve ball spaced from the valve seat, determining an effective surface area of the valve ball on which a fluid at a predetermined pressure needs to act to offset the spring force at each position of the valve ball as desired, determining the interface angle that corresponds to each determined effective surface area for each position of the valve ball, and then forming the valve bore with a shape that provides the determined interface angle at each position of the valve ball.

26. The method of claim 25 wherein the effective surface area and interface angle are chosen to provide a net force on the valve ball that offsets the increase in the spring force acting on the valve ball as the valve ball is increasingly displaced from the valve seat so that the pressure control valve has a substantially constant pressure response over a range of positions of the valve ball relative to the valve seat.
